(19) United States
(12) Patent Application Publication
(10) Pub. No.: US 2005/0106969 A1
(43) Pub. Date: May 19, 2005

(54) Finish protector

(76) Inventor: Joseph P. Roberts, Roselle, IL (US)

Correspondence Address: Mr. Kevin M. Slota;# 317, 904 S. Roselle Road, Schaumburg, IL, 60193, US

(21) Appl. No.: 10/715,196

(22) Filed: Nov. 17, 2003

(51) Int. Cl. B32B 5/02; B32B 3/00; B32B 9/00

(52) U.S. Cl. 442/149; 442/221; 442/286; 442/315; 442/370; 442/394; 428/904

(57) ABSTRACT

The invention/device is a removable, repositionable, non-slip finish protector that shields musical, stringed instruments from scratches, blemishes and abrasions caused by normal wear, guitar picks, belt buckles, zippers, buttons, snaps and decorative attire items. Although developed specifically for musical instruments, this invention will be used to protect any surface from wear and/or to provide a decorative working surface such as a display mat for use on counter tops in music stores and other retail outlets.

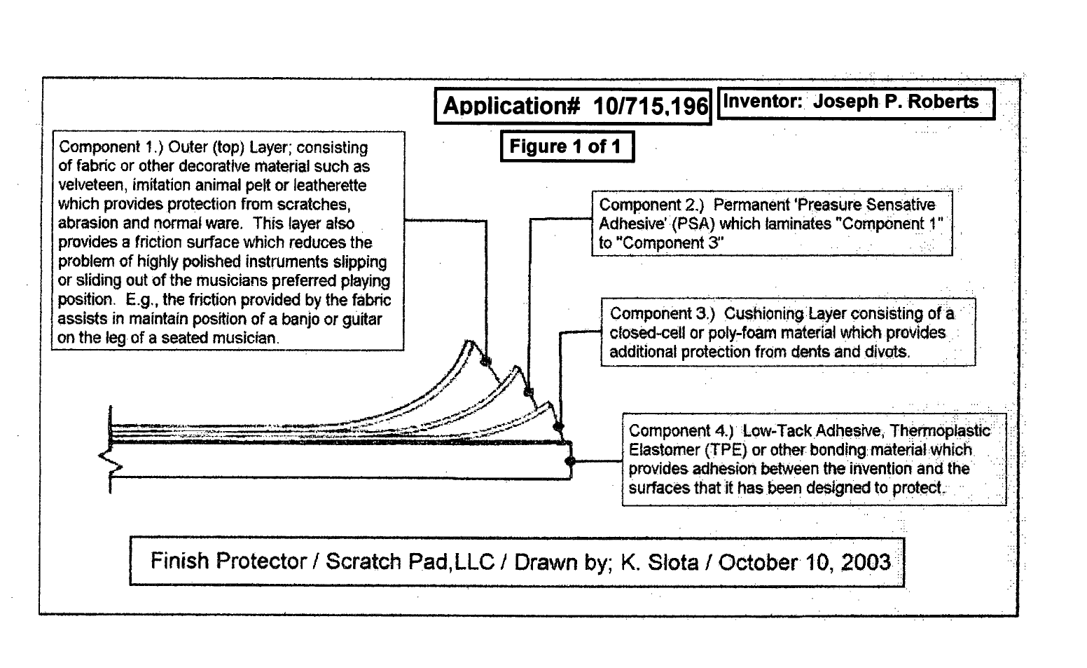

### BACKGROUND OF INVENTION

To protect the finishes of their stringed instruments, musicians such as Guitarist, Bass and Banjo Players rely on an un-tucked shirt, a towel draped over the front of their waistband or similar other method to protect their instruments from scratches, divots, blemishes and abrasions which are caused by; normal ware due to handling, guitar picks, belt buckles, zippers, snaps and decorative attire items such as metal studs applied to trousers, jackets and vests, etc.

Utilizing materials available in his home, Musician/inventor, Joseph Roberts devised a product prototype that could be applied to his guitar that would; 1.) provide protection from the damaging effects described above and, 2.) add to the decorative aesthetics of his instruments.

The first prototype included a thin vinyl component which provided the bonding properties that allowed the invention to adhere to the front, back and side surfaces of the instruments which were being protected however, it was soon determined that because the vinyl was a petroleum based product which could eventually cause certain guitar finishes such as nitrocellulose to deteriorate during prolonged exposure.

In addition to the problems caused by petroleum-based products, the vinyl film also possessed the properties of “Plasticizers.” Plasticizers are responsible for the vinyls' ability to bond to the surfaces to which it is applied. [The vinyls' bonding principal is best demonstrated by the vinyl stickers that are applied to the windshield of a vehicle during an oil change service.] Although providing an effective bond, the plasticizers contained within the vinyl could eventually migrate to the finish resulting in; 1.) damage to the finish of many stringed instruments and, 2.) causing the vinyl to eventually lose its ability to bond.

Several years of research & development have produced an alternate bonding solution in the form of a low-tack coating. This low-tack coating had proven to be compatible with the surfaces that the inventor sought to protect. Therefore the new low-tack coating solution has been selected for this design in place of the vinyl product.

Further testing and development has also resulted in the addition of a decorative fabric laminated with a permanent adhesive to a cushioning layer of foam sheeting for increased finish protection.

### SUMMARY OF INVENTION

### DETAILED DESCRIPTION

Scratch Pad is constructed from a multi-layered design which laminates the following components:

Component 1.) Outer (top) Layer; consisting of fabric or other decorative material such as velveteen, imitation animal pelt or leatherette which provides added protection from scratches, abrasion and normal ware. This layer also provides a textured (friction) surface which reduces the problem of highly polished instruments slipping or sliding out of the preferred playing position. E.g., the friction provided by the textured fabric assists in maintaining the position of a banjo or guitar on the leg of a seated musician.

Component 2.) a Permanent Adhesive which laminates “Component 1” (above) to “Component 3” (below.)

Component 3.) a Cushioning Layer consisting of a closed-cell or poly-foam material which provides additional protection from dents, dings and divots.

Component 4.) Low-Tack Adhesive, Thermoplastic Elastomer (TPE) or other bonding material which provides adhesion between the invention and the surfaces that it has been designed to protect.

Component 5.) Release Liner; prevents the “Bonding Material” described in “Component 4” (above) from attracting dust and other contaminants prior to and between applications. The invention is to be reapplied to this release liner whenever the invention is not applied to a surface which, the invention was designed to protect.

1.) A device for protecting the finished or unfinished surfaces (front, back, side bottom and top) of stringed musical instruments such as but limited to; electric & acoustic guitars, bass guitars, banjos, violins, violas, floor bass, steel guitars, ukuleles and mandolins, the invention comprised of the following components:
a.) A decorative outer (top) layer of natural fabric or synthetic material that provides protection from scratches, abrasion and normal ware. This outer (top) layer also provides a textured (friction) surface which reduces the problem of highly polished instruments slipping and/or sliding out of the musicians preferred playing position. E.g., the friction provided by the fabric assists in maintaining the position of a banjo or guitar on the leg of a seated musician.
b.) An inner layer of cushioning material [laminated to the decorative layer detailed above] provides additional protection from dings and divots.
c.) A Low-Tack Adhesive, Thermoplastic Elastomer.(TPE) or other bonding material provides adhesion between the invention and the surfaces that it has been designed to protect.
